(19) United States
(12) Patent Application Publication
(10) Pub. No.: US 2015/0070468 A1
(43) Pub. Date: Mar. 12, 2015

(54) USE OF A THREE-DIMENSIONAL IMAGER'S POINT CLOUD DATA TO SET THE SCALE FOR PHOTOGRAMMETRY

(71) Applicant: FARO Technologies, Inc., Lake Mary, FL (US)

(72) Inventor: Charles Pfeffer, Avondale, PA (US)

(21) Appl. No.: 14/470,975

(22) Filed: Aug. 28, 2014

Related U.S. Application Data
(60) Provisional application No. 61/875,801, filed on Sep. 10, 2013.

(51) Int. Cl. G01B 11/00; H04N 13/02

(52) U.S. Cl. CPC G01B 11/002; H04N 13/0275
USPC 348/46

(57) ABSTRACT

A triangulation-type, three-dimensional imager device uses photogrammetry to provide alignment or registration of the multiple point clouds of an object generated by the imager. The imager does not need a calibrated artifact such as a scale bar in its use of the photogrammetry process but instead uses the point cloud data generated by the imager to set the scale required by and utilized in the photogrammetry process.

### CROSS-REFERENCE TO RELATED APPLICATIONS

The present application claims priority to U.S. Provisional Patent Application No. 61/875,801, filed on Sep. 10, 2013, the entire contents of which are incorporated herein by reference.

### FIELD OF THE INVENTION

The subject matter disclosed herein relates in general to a triangulation-type, three-dimensional imager device that uses photogrammetry to provide alignment or registration of the multiple point clouds of an object generated by the imager, and in particular to such an imager that does not need a calibrated artifact such as a scale bar in its use of the photogrammetry process but instead uses the point cloud data generated by the imager to set the scale required by and utilized in the photogrammetry process.

### BACKGROUND OF THE INVENTION

The acquisition of three-dimensional (“3D”) coordinates of an object or an environment is known. Various data coordinate acquisition techniques may be used, for example, such as time-of-flight or triangulation methods. A time-of-flight system such as a laser tracker, total station, or laser scanner may direct a beam of light such as a laser beam towards a retroreflector target or a spot on the surface of the object. An absolute distance meter is used to determine the distance to the target or spot based on the length of time it takes the light to travel to the target or spot and return. By moving the laser beam or the target over the surface of the object, the coordinates of the object may be ascertained. Time-of-flight systems have some advantages such as relatively high accuracy, but in some cases may be slower than other systems since time-of-flight systems must usually measure each point on the surface individually.

In contrast, a 3D imager that uses the well-known triangulation method to measure the 3D coordinates of an object or environment typically projects onto a surface of the object either a pattern of light in a line (e.g., a laser line from a laser line probe) or a pattern of light covering an area (e.g., structured light from a 2D projector). A camera is coupled to the projector in a fixed relationship, for example, by attaching a camera and the projector to a common frame. The light emitted from the projector is reflected off of the object surface and detected by the camera. Since the camera and projector are arranged in a fixed relationship, the distance to the object may be determined using trigonometric principles. Compared to coordinate measurement devices that use tactile probes, triangulation systems provide advantages in quickly acquiring coordinate data over a large area. As used herein, the resulting collection of 3D coordinate values or data points of the object or environment being measured and provided by the triangulation system is referred to as point cloud data or simply a point cloud.

A 3D imager that uses triangulation techniques is often used to obtain the 3D coordinates of relatively large objects such as ships or airplanes. In many cases, the imager is only able to measure a relatively small portion or section of the overall object in a single measurement. As such, in order to measure the entire object the imager must be moved to several different locations around the object and point clouds must be obtained at each of the different measuring locations of the imager with respect to the object. It is then necessary to have a way to align or register (“stitch”) the multiple data point clouds together to arrive at the overall 3D image of the entire object.

One way to register the multiple point clouds is to tie together common features in the collected point clouds. That is, common features in two adjacent point clouds such as at least three non-collinear (i.e., two-dimensional) data points are imaged. This “partial overlap of point clouds” method is repeated for each pair of adjacent point clouds. Although this technique works well in some cases (in particular those in which the object being measured has a relatively large amount of details, for example, sharp curves), there are many cases in which this method is not satisfactory for accurately registering the multiple point clouds together. For example, the object being measured may not have enough detail to provide accurate matching of the multiple point cloud sections (for example, the object may have mostly smooth contours with little or no sharp curves). In another case, a large number of point clouds must be registered, and even a small error in each alignment of point clouds can result in the overall shape of the object being deformed. This is sometimes referred to as the “potato chip” effect.

A method that is widely used to overcome these limitations is to supplement the point cloud data relating to the object being measured and captured by the 3D imager with a “photo shoot” session using a photogrammetry system comprising a single calibrated camera (e.g., a digital camera), a number of photogrammetry targets, and one or more calibrated scale bars. With such a system, the photogrammetry targets are typically placed around the periphery of the object being measured. The photogrammetry targets may be relatively reflective flat targets, for example, Mylar disks having a special reflective coating. In other cases, the targets may be coded targets having a recognizable pattern that may be used to rapidly identify the particular target being viewed. The photogrammetry targets may be illuminated by strobing flash lamps, for example.

The calibrated camera is used to take photographs of the object from a variety of different positions with respect to the object. Enough digital photographs must be collected so that the photogrammetry targets overlap in multiple images of the digital camera. Some (e.g., at least one) of the digital photographs may be collected with the camera rotated by ninety degrees to provide correction for camera aberrations. Importantly, each of the digital photographs must include an image of the scale bar(s) to set the scale for all of the photographs, thereby correcting for any scaling differences in the photographs. Such scaling differences may be caused, for example, by taking two different pictures of the object from two different distances of the camera from the object. This will cause the object to be of a different size as between the two pictures. Finally, enough photographs must be collected so that the 3D point cloud images of the object can be accurately registered or stitched together.

After all of the digital photographs are collected, a bundle adjustment procedure is typically carried out to determine: (1) the 3D coordinates of all of the photogrammetry targets (within an arbitrary frame of reference); (2) the 6D coordinates of the camera in each of its poses or positions; and (3) the camera internal compensation parameters that account for camera aberrations. The bundle adjustment method may be any of several well-known mathematical optimization methods that combine information obtained from several different measurement orientations in order to minimize errors in the (redundant) measurements. The bundle adjustment procedure may comprise three separate procedures that may be run simultaneously or near simultaneously: (1) triangulation, whereby intersecting lines in space are used to compute the location of a point in all three dimensions; (2) resection, which determines the camera position and aiming angles (i.e., the “orientation”) of all of the pictures taken; and (3) self-calibration, whereby the photogrammetry camera is calibrated as a function of the photogrammetry measurements. Once the 3D coordinates of the photogrammetry targets are established self-consistently, the positions of the point clouds may be determined since some of the photogrammetry targets are captured in conjunction with each of the point cloud images. As long as a point cloud captured by the scanner in a particular pose includes at least three non-collinear photogrammetry targets, the point cloud may be in effect “hung” onto the full collection of registered photogrammetry targets provided by the camera measurements. This process is repeated for each of the point clouds, thereby providing mutual registration for each of the point clouds.

The above photogrammetry method in general works relatively well but has some shortcomings. For example, with the customary photogrammetry method, it is necessary to include at least one calibrated artifact such as a scale bar in each photograph. Such scale bar artifacts are often large, are relatively expensive, and must be transported to each measurement site. The need to frequently ship the artifact from site to site increases the likelihood that the artifact will be knocked out of calibration. If the scale bar is out of calibration, then the data obtained by the 3D imager during the object data capture process cannot be accurately registered and, thus, cannot be used to accurately replicate the object being measured.

Accordingly, while existing triangulation-based 3D imager devices that use photogrammetry methods are suitable for their intended purpose, the need for improvement remains, particularly in providing a photogrammetry process that does not utilize a calibrated artifact such as a scale bar to set the scale for all of the photographs taken during the photogrammetry process.

### BRIEF DESCRIPTION OF THE INVENTION

According to an embodiment of the present invention, a method for measuring three-dimensional coordinates of a surface includes providing a structured light scanner, a photogrammetry camera, a collection of photogrammetry targets, and a processor, the scanner including a projector and a scanner camera, the scanner having a first frame of reference, the projector configured to project a structured light onto the surface, the projector having a projector perspective center, the scanner camera including a scanner photosensitive array and a scanner camera lens, the scanner camera having a scanner camera perspective center, the scanner camera lens being configured to form an image of a portion of the surface on the scanner photosensitive array and to produce a scanner electrical signal in response, the processor configured to receive a scanner digital signal corresponding to the scanner electrical signal, the scanner having a baseline, the baseline being a straight line segment between the projector perspective center and the scanner camera perspective center, the projector having a projector orientation in the first frame of reference, the scanner camera having a scanner camera orientation in the first frame of reference, the photogrammetry camera including a photogrammetry lens and a photogrammetry photosensitive array, the photogrammetry camera having a second frame of reference, the photogrammetry lens being configured to form an image of a part of the surface on the photogrammetry photosensitive array and to produce a photogrammetry electrical signal in response, the processor further configured to receive a photogrammetry digital signal corresponding to the photogrammetry electrical signal.

The method also includes attaching the collection of photogrammetry targets to the surface, placing the scanner at a first location; generating with the projector a first structured light pattern at a first time; projecting the first structured light pattern onto a first portion of the surface to produce a first reflected light; receiving the first reflected light with the camera lens; forming with the camera lens a first image of the first reflected light on the scanner photosensitive array and generating in response a first scanner digital signal; sending the first scanner digital signal to the processor; determining with the processor first three-dimensional coordinates of points on the first portion of the surface, the first three-dimensional coordinates based at least in part on the first structured light, the first scanner digital signal, the projector orientation in the first frame of reference, the scanner camera orientation in the first frame of reference, and a length of the baseline; determining with the processor first target coordinates, the first target coordinates being three-dimensional coordinates of the at least three photogrammetry targets in the first portion based at least in part on the first three-dimensional coordinates.

The method also includes placing the scanner at a second location; generating with the projector a second structured light pattern at a second time; projecting the second structured light pattern onto a second portion of the surface to produce a second reflected light; receiving the second reflected light with the camera lens; forming with the camera lens a second image of the second reflected light on the scanner photosensitive array and generating in response a second scanner digital signal; sending the second scanner digital signal to the processor.

The method further includes determining with the processor second three-dimensional coordinates of points on the second portion of the surface, the second three-dimensional coordinates based at least in part on the second structured light, the second scanner digital signal, the projector orientation in the first frame of reference, the scanner camera orientation in the first frame of reference, and the length of the baseline; determining with the processor second target coordinates, the second target coordinates being three-dimensional coordinates of a second portion of the collection of photogrammetry targets in the second portion based at least in part on the second three-dimensional coordinates.

The method also includes placing the photogrammetry camera at a third location; forming with the photogrammetry lens a third image of the collection of photogrammetry targets on the photogrammetry photosensitive array and generating in response a first photogrammetry digital signal; sending the first photogrammetry digital signal to the processor; placing the photogrammetry camera at a fourth location; forming with the photogrammetry lens a fourth image of the collection of photogrammetry targets on the photogrammetry photosensitive array and generating in response a second photogrammetry digital signal; sending the second photogrammetry digital signal to the processor.

The method further includes determining three-dimensional coordinates of a combined portion of photogrammetry targets, the combined portion of photogrammetry targets including the first portion of the collection of the photogrammetry targets and the second portion of the collection of photogrammetry targets, the coordinates of the combined portion of photogrammetry targets based at least in part on the first photogrammetry digital signal, the second photogrammetry digital signal, the first target coordinates, and the second target coordinates, wherein scaling of the three-dimensional coordinates of the combined portion of photogrammetry targets is based at least in part on at least one distance between the photogrammetry targets, the at least one distance determined based on the first target coordinates or the second target coordinates; and storing the three-dimensional coordinates of the combined portion of photogrammetry targets.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a perspective view of a 3D imager in two different positions with respect to several objects being measured by the imager;

FIG. 2 is a perspective view of a photogrammetry camera in two different positions with respect to the several objects being measured by the imager;

FIG. 3 is a perspective view of a structured light triangulation scanner that projects a pattern of light over an area on a surface; and

FIG. 4 is a perspective view of a photogrammetry camera that includes a photogrammetry camera lens and a photogrammetry camera photosensitive array.

The detailed description explains embodiments of the invention, together with advantages and features, by way of example with reference to the drawings.

### DETAILED DESCRIPTION OF THE INVENTION

Embodiments of the present invention provide advantages in three-dimensional imagers by removing the need to use a calibrated artifact such as a scale bar when using photogrammetry techniques in conjunction with the triangulation-type 3D imagers. Also, embodiments of the present invention provide advantages in using the inherent 3D measurement accuracy of the 3D imager to establish the scale for the photogrammetry system instead of using a scale bar.

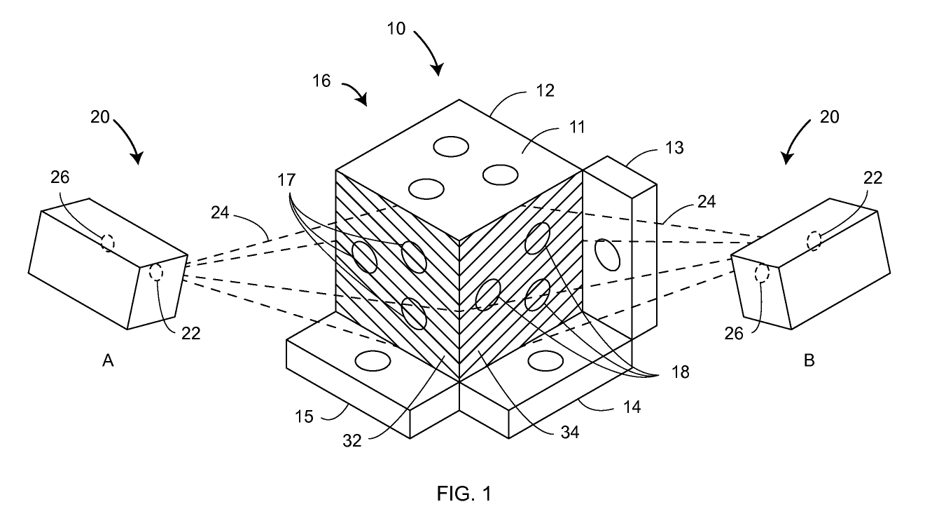

Referring to FIG. 1, in accordance with embodiments of the present invention, there illustrated is an object 10 that includes a surface 11 which encompasses an object of interest 12, along with several other background objects 13, 14, 15. Here, for example, it is desired to obtain 3D measurements of the physical features of the object 10. Detailed features of the surface 11 of the object 10 may be measured using a 3D triangulation-type imager 20 together with photogrammetry components, including a camera and targets. However, in accordance with embodiments of the present invention and in contrast to prior art photogrammetry devices and methods, no type of scaled artifact is needed, such as a scale bar, when making the coordinate measurements of the object 10. Instead, as will be described in detail hereinafter, embodiments of the present invention make use of the inherent 3D measurement accuracy of the triangulation type 3D imager 20 to establish the necessary scale for the photogrammetry system.

In an embodiment of the present invention, a number of photogrammetry targets 16 are affixed to the surface 11. The photogrammetry targets 16 may be reflecting elements such as reflecting spots or they may be sources of light such as LEDs. The 3D triangulation imager 20 includes a projector 22 and a camera 26. The projector projects, for example, a 2D pattern of structured light over a field of view (FOV) 24 that overlaps the FOV of the camera 26.

The projector 22 and the camera 26 are typically arranged in a fixed relationship at an angle such that a sensor in the camera 26 may receive light reflected from the surface 11 of the object 10. Since the projector 22 and the camera 26 have a fixed geometric relationship, the distance and the coordinates of points on the surface 11 of the object 10 may be determined by their trigonometric relationships.

In an exemplary embodiment, the projector 22 uses a visible light source that illuminates a pattern generator. The visible light source may be a laser, a superluminescent diode, an incandescent light, a Xenon lamp, a light emitting diode (LED), or other light emitting device for example. In one embodiment, the pattern generator is a chrome-on-glass slide having a structured light pattern etched thereon. The slide may have a single pattern or multiple patterns that move in and out of position as needed. The slide may be manually or automatically installed in the operating position. In other embodiments, the source structured light pattern may be light reflected off or transmitted by a digital micro-mirror device (DMD) such as a digital light projector (DLP) manufactured by Texas Instruments Corporation, a liquid crystal device (LCD), a liquid crystal on silicon (LCOS) device, or a similar device used in transmission mode rather than reflection mode. The projector 22 may further include a lens system that alters the outgoing light to cover the desired area.

In an embodiment, the projector 22 is configurable to emit a structured light pattern over an area. As used herein, the term “structured light” refers to a two-dimensional pattern of light projected onto an area of an object that conveys information which may be used to determine coordinates of points on the object. In one embodiment, a structured light pattern will contain at least three non-collinear (i.e., 2D) pattern elements disposed within the area. Each of the non-collinear pattern elements conveys information which may be used to determine the point coordinates. In another embodiment, a projector is provided that is configurable to project both an area pattern as well as a line pattern. In one embodiment, the projector is a digital micromirror device (DMD), which is configured to switch back and forth between the two. In another embodiment, the DMD projector may also sweep a line or to sweep a point in a raster pattern.

In general, there are two types of structured light patterns, a coded light pattern and an uncoded light pattern. As used herein a coded light pattern is one in which the three dimensional coordinates of an illuminated surface of the object are found by acquiring a single image. With a coded light pattern, it is possible to obtain and register point cloud data while the projecting device is moving relative to the object. One type of coded light pattern contains a set of elements (e.g. geometric shapes) arranged in lines where at least three of the elements are non-collinear. Such pattern elements are recognizable because of their arrangement.

In contrast, an uncoded structured light pattern as used herein is a pattern that does not allow measurement through a single pattern. A series of uncoded light patterns may be projected and imaged sequentially. For this case, it is usually necessary to hold the projector fixed relative to the object.

As stated above, the imager 20 may use either coded or uncoded structured light patterns. The structured light pattern may include the patterns disclosed in the journal article “DLP-Based Structured Light 3D Imaging Technologies and Applications” by Jason Geng published in the Proceedings of SPIE, Vol. 7932, which is incorporated herein by reference. In addition, in some embodiments described herein below, the projector 22 may transmit a pattern formed by a swept line of light or a swept point of light. Swept lines and points of light provide advantages over areas of light in identifying some types of anomalies such as multipath interference. Sweeping the line automatically while the scanner is held stationary also has advantages in providing a more uniform sampling of surface points.

In accordance with an exemplary embodiment of the present invention, at a first point in time, the imager 20 is placed at a first location, “A,” in FIG. 1 with respect to the object 10 and projects a two-dimensional pattern of structured light over a first portion 32 of the surface of the object 10 as indicated in FIG. 1 by a first set of hatched lines. A collection of photogrammetry targets 17 are intercepted by the structured light. The camera 26 captures light reflected by the first portion 32 and uses a lens in the camera to form an image on a photosensitive array within the camera.

At a second point in time, the imager 20 is placed at a second location, “B,” with respect to the object 10 and projects a 2D pattern of structured light over a second portion 34 of the surface of the object 10 as indicated by a second set of hatched lines. The camera 26 captures light reflected by the second portion 34 and forms an image on the photosensitive array. A controller located within the imager 20 or external thereto evaluates the point cloud data from the imager 20 to determine the 3D coordinates of the points on the first surface 32 and the second surface 34 of the object 10. The processor also determines the positions of the photogrammetry targets 17 on the first surface 32 (i.e., the first target coordinates) and the photogrammetry targets 18 on the second surface 34 (i.e., the second target coordinates). At the first and second points of time, where the camera is collecting different images, each of the images is collected in a frame of reference of the camera. In other words, both images are collected in a local frame of reference and not a global or world frame of reference.

The projector 22 and camera 26 are electrically coupled to the controller (processor), which may include one or more microprocessors, digital signal processors, memory and signal conditioning circuits. The 3D imager 20 may further include actuators (not shown) which may be manually activated by the operator to initiate operation and data capture by the imager 20. Alternatively, the imager 20 may be hand-held and moved about to different positions with respect to the object 10 by a user. In one embodiment, the image processing to determine the X, Y, Z coordinate data of the point cloud representing the surface 11 of object 10 is performed by the controller. The coordinate data may be stored locally such as in a volatile or nonvolatile memory for example. The memory may be removable, such as a flash drive or a memory card for example. In other embodiments, the imager 20 has a communications circuit that allows the imager 20 to transmit the coordinate data to a remote processing system. The communications medium between the imager 20 and the remote processing system may be wired (e.g. Ethernet) or wireless (e.g. Bluetooth, IEEE 802.11). In one embodiment, the coordinate data is determined by the remote processing system based on acquired images transmitted by the imager 20 over the communications medium.

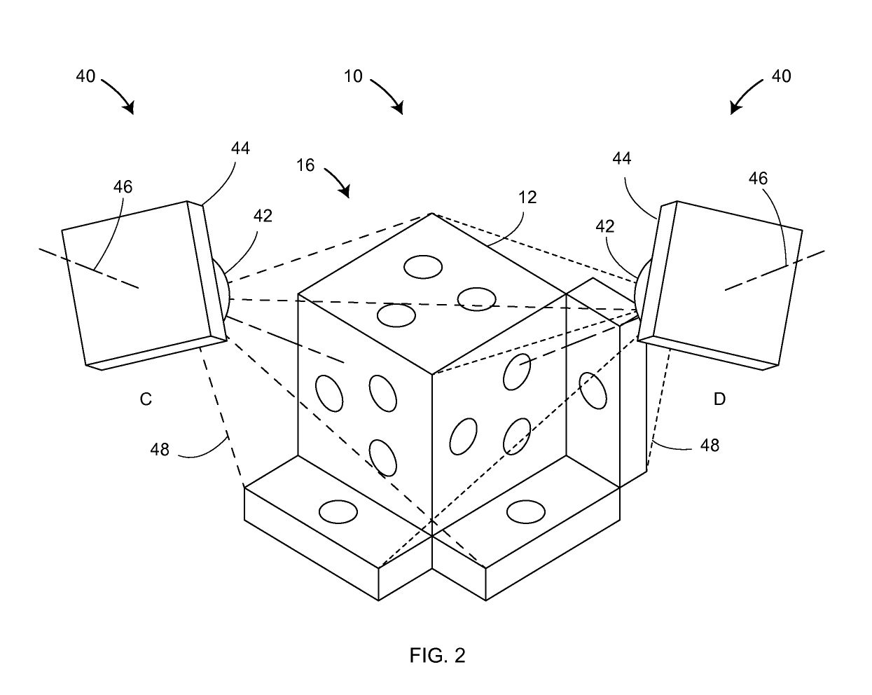

Referring to FIG. 2, the object 10 is again illustrated therein. A photogrammetry camera 44 having an optical axis 46 and a FOV 48 is placed at a third location, “C,” with respect to the object 10. A lens in the photogrammetry camera 44 forms an image of the collection of photogrammetry targets on a photosensitive array within the photogrammetry camera. Next, the photogrammetry camera 44 is placed at a fourth location, “D,” with respect to the object 10. An image of the collection of photogrammetry targets is obtained with the camera 44.

In general, the photogrammetry camera will in each view capture a relatively large number of photogrammetry targets, thereby enabling the determination of a “frame of points” on which the individual scan data, each of which generally covers a smaller surface region, to be “hung” on the frame of points.

In the prior art, this information regarding the scale of the objects in the photogrammetry photos or images has been obtained by providing a calibrated artifact such as a scale bar in each image obtained by the photogrammetry camera. However, providing a scale bar adds time and expense in purchasing, calibrating, and shipping transporting the bar. Also, if the scale bar becomes uncalibrated for any reason (e.g., by dropping it), but it is still used during the photogrammetry “photo shoot,” then all of the image information obtained by the 3D imager 20 of an object measured by the 3D imager 20 is invalid, since the scale was incorrect.

Embodiments of the present invention overcome these problems involving use of a physical scale bar artifact by using instead the inherently accurate scale information provided by the measured target coordinates such as the coordinates of the photogrammetry targets 17 and 18, respectively, obtained with the 3D imager 20. That is, the processor uses one or more lengths between the known 3D coordinates of the targets 17, 18 to provide a scale for the photogrammetry in lieu of a dedicated scale bar.

The essentially physical property being used to advantage here is the invariance of the distance between the photogrammetry targets, such as the targets 17 and 18, whether viewed from one of the scanner positions A, B or one of the photogrammetry camera positions C, D.

Thus, the inherent 3D measurement accuracy of the 3D imager 20 is used to establish the scale for the photogrammetry system. To do this, the distance between each pair of photogrammetry targets 17, 18 is determined for each point cloud obtained by the 3D imager 20. These distances are used in the bundle adjustment (i.e., optimization) calculation of the digital data collected by the photogrammetry camera 44. In other words, the distances determined by the 3D imager 20 are used in place of the distances customarily provided by the scale bar.

With the proper scaling provided, the controller determines the 3D coordinates for all the photogrammetry targets in a world frame of reference. Using the correspondence described above, the photogrammetry targets from the first and second portions can be “hung” onto the known 3D coordinates provided by the photogrammetry cameras 44. This action then brings all the scan data for the first and second portions into alignment. Any number of scans can likewise be connected onto the common frame of photogrammetry targets as obtained using the photogrammetry cameras.

Thus, when using a 3D imager 20 with a photogrammetry system, it is possible to set the scale for photogrammetry using the known coordinates from specific points within one or more point clouds from the 3D imager 20. This method sets the scale for photogrammetry by defining the lengths between targets 17, 18 prior to the photogrammetry shoot. The photogrammetry shoot can then define the reference systems for the 3D imager point cloud registration.

As seen from the foregoing, in a broader sense if there is another traceable measurement system available that can be used to establish scale, then a traditional artifact such as a scale bar may not be required to complete a photogrammetry measurement. When both the 3D imager 20 and the photogrammetry systems are required to completely measure an object, it would be possible to use the 3D imager's traceable point cloud to set the scale for the photogrammetry, thus eliminating the requirement for a scale bar or other scale artifact to be available.

Small area 3D imaging that covers areas up to, for example, two meters at a time is used to generate comprehensive point clouds of parts, tools, assemblies and other objects. This method typically requires combining individual sets of point cloud data into one. Combining this data relies on common overlapping features in the point clouds which are not always available due to part geometry and lines of sight. Another case where the use of common features can be problematic is when the part is larger enough to require several overlapping images that extend in one direction. This condition incrementally adds uncertainty.

Photogrammetry is used to handle cases where overlapping features introduce too much uncertainty in the point cloud registration. The photogrammetry technique uses targets to create a reference system on and around the part, tool or object to be measured. The 3D imager 20 then collects the 3D coordinates for the same targets as part of the point cloud collection, which enables each point cloud to be fit into the pre-established photogrammetry target reference system.

When using a 3D imager with a photogrammetry reference system, it is possible to set the scale for the photogrammetry bundle with one or more point clouds from the 3D imager 20. With typical 3D imager accuracy better than 25 microns in areas of 600 mm, this creates a method of setting scale for photogrammetry by defining the lengths between targets prior to the photogrammetry shoot, or alternatively, the photogrammetry shoot can be carried out first, and the scaling data from the scans used in a postprocessing step.

According to an embodiment of the present invention, a method for using the 3D imager 20 and photogrammetry equipment with an independently measured and calculated scale (i.e., no physical scale bar or other physical calibrated artifact is needed) may be as follows: (1) Apply targets to the object and fixtures as needed for proper measurement of the object; (2) Capture point clouds with targets in the field of view with the 3D imager 20; (3) Calculate distances between all targets in the field of view; (4) Move the 3D imager 20 and repeat steps (2) and (3) in other areas of the object for more coverage as needed; (5) Perform photogrammetry survey with sufficient coverage of object and fixtures to create a reference system for 3D imager point cloud registration; (6) Bundle photogrammetric targets using distances between targets as calculated from 3D imager measurements to set scale; and (7) Perform additional 3D imager measurements as required and fit point clouds to reference.

At first glance, this method may appear to be a circular calculation, but in fact it is not. The scale for the photogrammetry is defined by the traceable measurements of the 3D imager 20. The scale is then used to generate a reference system for the 3D imager 20 to complete a comprehensive measurement of a part or tool that requires target fitting to register the point clouds together.

According to another embodiment of the present invention, a method for measuring three-dimensional coordinates of a surface includes providing a structured light scanner, a photogrammetry camera, a collection of photogrammetry targets, and a processor. The scanner includes a projector and a scanner camera. The scanner has a first frame of reference. The projector is configured to project a structured light onto the surface. The projector has a projector perspective center. The scanner camera includes a scanner photosensitive array and a scanner camera lens. The scanner camera has a scanner camera perspective center. The scanner camera lens is configured to form an image of a portion of the surface on the scanner photosensitive array and to produce a scanner electrical signal in response. The processor is configured to receive a scanner digital signal corresponding to the scanner electrical signal. The scanner has a baseline, the baseline being a straight line segment between the projector perspective center and the scanner camera perspective center. The projector has a projector orientation in the first frame of reference. The scanner camera has a scanner camera orientation in the first frame of reference.

The photogrammetry camera includes a photogrammetry lens and a photogrammetry photosensitive array. The photogrammetry camera has a second frame of reference. The photogrammetry lens is configured to form an image of a part of the surface on the photogrammetry photosensitive array and to produce a photogrammetry electrical signal in response. The processor is further configured to receive a photogrammetry digital signal corresponding to the photogrammetry electrical signal.

The method also includes attaching the collection of photogrammetry targets to the surface, wherein the collection of photogrammetry targets includes at least three non-collinear photogrammetry targets in a first portion of the surface and at least three non-collinear photogrammetry targets in a second portion of the surface. The first portion and the second portion may overlap. The at least three photogrammetry targets in the first portion and the at least three photogrammetry targets in the second portion may be shared in part or in whole by the first portion and the second portion.

The method further includes placing the scanner at a first location; generating with the projector a first structured light pattern at a first time; projecting the first structured light pattern onto a first portion of the surface to produce a first reflected light; receiving the first reflected light with the camera lens; forming with the camera lens a first image of the first reflected light on the scanner photosensitive array and generating in response a first scanner digital signal.

The method still further includes sending the first scanner digital signal to the processor; determining with the processor first three-dimensional coordinates of points on the first portion of the surface, the first three-dimensional coordinates based at least in part on the first structured light, the first scanner digital signal, the projector orientation in the first frame of reference, the scanner camera orientation in the first frame of reference, and a length of the baseline; determining with the processor first target coordinates, the first target coordinates being three-dimensional coordinates of the at least three photogrammetry targets in the first portion based at least in part on the first three-dimensional coordinates.

The method also includes placing the scanner at a second location; generating with the projector a second structured light pattern at a second time; projecting the second structured light pattern onto a second portion of the surface to produce a second reflected light; receiving the second reflected light with the camera lens; forming with the camera lens a second image of the second reflected light on the scanner photosensitive array and generating in response a second scanner digital signal.

The method further includes sending the second scanner digital signal to the processor; determining with the processor second three-dimensional coordinates of points on the second portion of the surface, the second three-dimensional coordinates based at least in part on the second structured light, the second scanner digital signal, the projector orientation in the first frame of reference, the scanner camera orientation in the first frame of reference, and the length of the baseline; determining with the processor second target coordinates, the second target coordinates being three-dimensional coordinates of the at least three photogrammetry targets in the second portion based at least in part on the second three-dimensional coordinates.

The method also includes placing the photogrammetry camera at a third location; forming with the photogrammetry lens a third image of the collection of photogrammetry targets on the photogrammetry photosensitive array and generating in response a first photogrammetry digital signal; sending the first photogrammetry digital signal to the processor.

The method further includes placing the photogrammetry camera at a fourth location; forming with the photogrammetry lens a fourth image of the collection of photogrammetry targets on the photogrammetry photosensitive array and generating in response a second photogrammetry digital signal; sending the second photogrammetry digital signal to the processor.

The method also includes determining three-dimensional coordinates of a combined portion of photogrammetry targets, the combined portion of photogrammetry targets including the first portion of the collection of the photogrammetry targets and the second portion of the collection of photogrammetry targets, the coordinates of the combined portion of photogrammetry targets based at least in part on the first photogrammetry digital signal, the second photogrammetry digital signal, the first target coordinates, and the second target coordinates, wherein scaling of the three-dimensional coordinates of the combined portion of photogrammetry targets is based at least in part on at least one distance between the photogrammetry targets, the at least one distance determined based on the first target coordinates or the second target coordinates; and storing the three-dimensional coordinates of the combined portion of photogrammetry targets.

Further, in the step of determining three-dimensional coordinates of a combined portion of photogrammetry targets, scaling of the three-dimensional coordinates of the combined portion of photogrammetry targets is further based at least in part on a plurality of distances between the photogrammetry targets, the plurality of distances determined based on the first target coordinates or the second target coordinates.

Alternatively, the method also includes determining with the processor out-of-scale three-dimensional coordinates for each of the photogrammetry targets in the collection of photogrammetry targets based at least in part on the first photogrammetry digital signal and the second photogrammetry digital signal; determining a correspondence between the targets having first target coordinates, the targets having second target coordinates, and the targets having out-of-scale three-dimensional coordinates; selecting a first photogrammetry target and a second photogrammetry target, wherein the first photogrammetry target and the second photogrammetry target are either both targets that have first target coordinates or are both targets that have second target coordinates; determining with the processor a scale factor based at least in part on the out-of-scale three-dimensional coordinates of the first photogrammetry target, the out-of-scale three-dimensional coordinates of the second photogrammetry target, the three dimensional coordinates of the first photogrammetry target, and the three-dimensional coordinates of the second photogrammetry target; determining with the processor three-dimensional coordinates of each of the photogrammetry targets in the collection of photogrammetry targets by multiplying the out-of-scale three-dimensional coordinates by the scale factor, the three-dimensional coordinates being given in a world frame of reference; determining first world target coordinates and first world three-dimensional coordinates, the first world target coordinates being obtained by transforming with the processor the first target coordinates and the first world three-dimensional coordinates being obtained by transforming with the processor the first three-dimensional coordinates into the world frame of reference; determining second world target coordinates and second world three-dimensional coordinates, the second world target coordinates being obtained by transforming with the processor the second target coordinates and the second world three-dimensional coordinates being obtained by transforming with the processor the second three-dimensional coordinates into the world frame of reference; and storing the first world target coordinates, the first world three-dimensional coordinates, the second world target coordinates, and the second world three-dimensional coordinates.

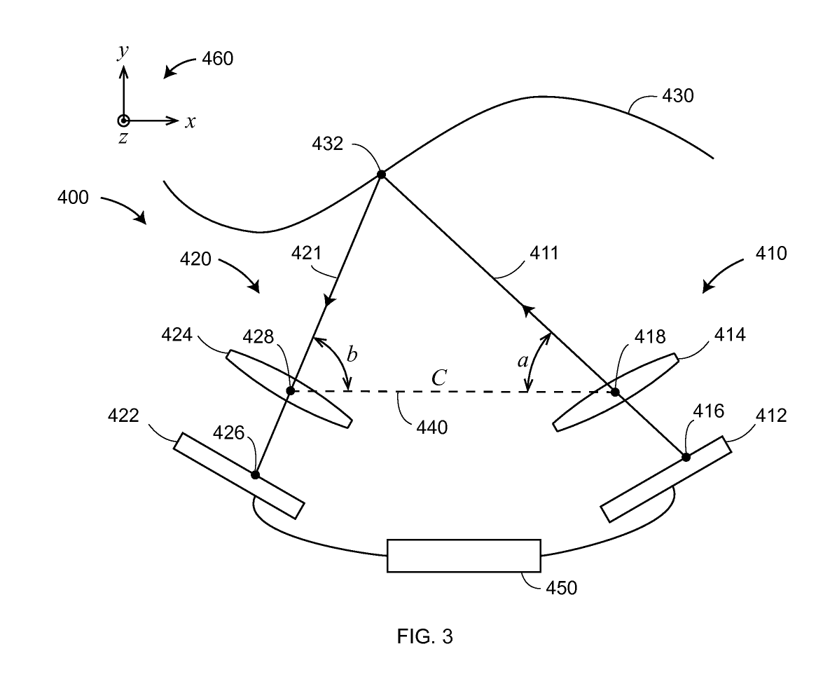

FIG. 3 shows a structured light triangulation scanner 400 that projects a pattern of light over an area on a surface 430. The scanner, which has a frame of reference 460, includes a projector 410 and a camera 420. The projector 410 includes an illuminated projector pattern generator 416, a projector lens 414, and a perspective center 418 through which a ray of light 411 emerges. The ray of light 411 emerges from a corrected point 416 having a position 416. The point 416 has been corrected to account for aberrations of the projector, including aberrations of the lens 414, in order to cause the ray to pass through the perspective center, thereby simplifying triangulation calculations.

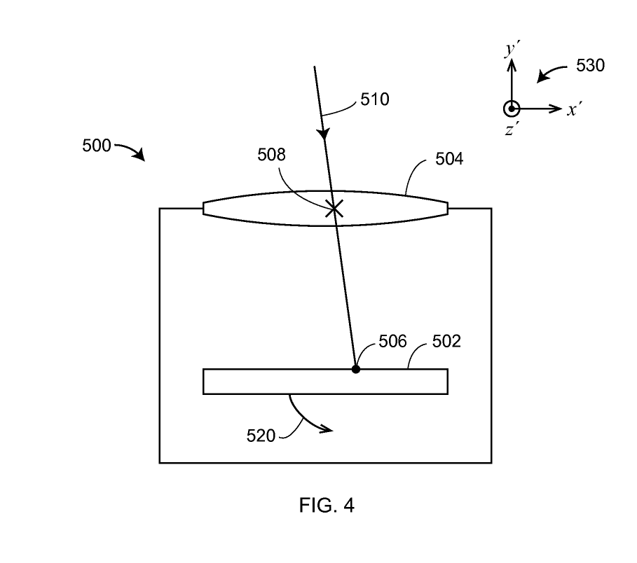

The ray of light 411 intersects the surface 430 in a point 432, which is reflected (scattered) off the surface and is sent through the lens 424 to create a clear image of the pattern on the surface 430 on the surface of a photosensitive array 422. The light from the point 432 passes through the camera perspective center 428 to form an image spot at the corrected point 426. The image spot is corrected in position to correct for aberrations in the camera lens. A correspondence is obtained between the point 426 on the photosensitive array 422 and the point 416 on the illuminated projector pattern 416. As explained hereinbelow, the correspondence may be obtained by using a coded or an uncoded (sequentially projected) pattern. Once the correspondence is known, the angles a and b in FIG. 4 may be determined. The baseline 440, which is a line segment drawn between the perspective centers 418, 428, has a length C. Knowing the angles a, b and the length C, all the angles and side lengths of the triangle 428-432-418 may be determined. Digital image information is transmitted to a processor 450, which determines 3D coordinates of the surface 430. The processor 450 may also instruct the illuminated pattern generator 412 to generate an appropriate pattern. The processor 450 may be located within the scanner assembly, or it may be an external computer, or a remote server.

FIG. 4 shows a photogrammetry camera 500, which includes a photogrammetry camera lens 504 and a photogrammetry camera photosensitive array 502. A ray of light from an illuminated point on an object surface passes through a perspective center 508 of the photogrammetry camera and intersects the photogrammetry camera photosensitive array in a point 506. Digital information is sent from the photosensitive array is sent over a line 520 to a processor. The line 520 may be a wired or wireless communication channel. The processor may be within the camera or within an external computer or remote server. The processor may be the same as the processor of the scanner 400 or different. It should be understood that the processor may also be distributed, for example, including separated microprocessors, field programmable gate arrays (FPGA), digital signal processor (DSPs), memory, and the like. The photogrammetry camera has a frame of reference 530.

In an embodiment, the measured 3D coordinates of the surface, which may be obtained from multiple scan sets and registered together using the photogrammetry targets, is compared to a CAD model having mechanical tolerances. The measured 3D coordinates are compared to the nominal 3D coordinates (as indicated on the CAD model), and the differences compared to the allowable tolerances to determine whether a part is within specification. If the part is not within specification, it may be rejected or reworked. In an embodiment, test results may be printed in a report or displayed graphically on a monitor, for example, by using a whisker diagram or errors may be displayed using colors. Test results may be saved.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A method for measuring three-dimensional coordinates of a surface comprising steps of:
providing a structured light scanner, a photogrammetry camera, a collection of photogrammetry targets, and a processor, the scanner including a projector and a scanner camera, the scanner having a first frame of reference, the projector configured to project a structured light onto the surface, the projector having a projector perspective center, the scanner camera including a scanner photosensitive array and a scanner camera lens, the scanner camera having a scanner camera perspective center, the scanner camera lens being configured to form an image of a portion of the surface on the scanner photosensitive array and to produce a scanner electrical signal in response, the processor configured to receive a scanner digital signal corresponding to the scanner electrical signal, the scanner having a baseline, the baseline being a straight line segment between the projector perspective center and the scanner camera perspective center, the projector having a projector orientation in the first frame of reference, the scanner camera having a scanner camera orientation in the first frame of reference, the photogrammetry camera including a photogrammetry lens and a photogrammetry photosensitive array, the photogrammetry camera having a second frame of reference, the photogrammetry lens being configured to form an image of a part of the surface on the photogrammetry photosensitive array and to produce a photogrammetry electrical signal in response, the processor further configured to receive a photogrammetry digital signal corresponding to the photogrammetry electrical signal;
attaching the collection of photogrammetry targets to the surface;
placing the scanner at a first location;
generating with the projector a first structured light pattern at a first time;
projecting the first structured light pattern onto a first portion of the surface to produce a first reflected light;
receiving the first reflected light with the camera lens;
forming with the camera lens a first image of the first reflected light on the scanner photosensitive array and generating in response a first scanner digital signal;
sending the first scanner digital signal to the processor;
determining with the processor first three-dimensional coordinates of points on the first portion of the surface, the first three-dimensional coordinates based at least in part on the first structured light, the first scanner digital signal, the projector orientation in the first frame of reference, the scanner camera orientation in the first frame of reference, and a length of the baseline;
determining with the processor first target coordinates, the first target coordinates being three-dimensional coordinates of a first portion of the collection of photogrammetry targets based at least in part on the first three-dimensional coordinates;
placing the scanner at a second location;
generating with the projector a second structured light pattern at a second time;
projecting the second structured light pattern onto a second portion of the surface to produce a second reflected light;
receiving the second reflected light with the camera lens;
forming with the camera lens a second image of the second reflected light on the scanner photosensitive array and generating in response a second scanner digital signal;
sending the second scanner digital signal to the processor;
determining with the processor second three-dimensional coordinates of points on the second portion of the surface, the second three-dimensional coordinates based at least in part on the second structured light, the second scanner digital signal, the projector orientation in the first frame of reference, the scanner camera orientation in the first frame of reference, and the length of the baseline;
determining with the processor second target coordinates, the second target coordinates being three-dimensional coordinates of a second portion of the collection of photogrammetry targets based at least in part on the second three-dimensional coordinates;
placing the photogrammetry camera at a third location;
forming with the photogrammetry lens a third image of the collection of photogrammetry targets on the photogrammetry photosensitive array and generating in response a first photogrammetry digital signal;
sending the first photogrammetry digital signal to the processor;
placing the photogrammetry camera at a fourth location;
forming with the photogrammetry lens a fourth image of the collection of photogrammetry targets on the photogrammetry photosensitive array and generating in response a second photogrammetry digital signal;
sending the second photogrammetry digital signal to the processor;
determining three-dimensional coordinates of a combined portion of photogrammetry targets, the combined portion of photogrammetry targets including the first portion of the collection of the photogrammetry targets and the second portion of the collection of photogrammetry targets, the coordinates of the combined portion of photogrammetry targets based at least in part on the first photogrammetry digital signal, the second photogrammetry digital signal, the first target coordinates, and the second target coordinates, wherein scaling of the three-dimensional coordinates of the combined portion of photogrammetry targets is based at least in part on at least one distance between the photogrammetry targets, the at least one distance determined based on the first target coordinates or the second target coordinates; and
storing the three-dimensional coordinates of the combined portion of photogrammetry targets.

2. The method of claim 1, further comprising storing the first three-dimensional coordinates of the points on the first portion of the surface.

3. The method of claim 1, further comprising storing the second three-dimensional coordinates of the points on the second portion of the surface.

4. The method of claim 1, wherein in the step of determining three-dimensional coordinates of a combined portion of photogrammetry targets, scaling of the three-dimensional coordinates of the combined portion of photogrammetry targets is further based at least in part on a plurality of distances between the photogrammetry targets, the plurality of distances determined based on the first target coordinates or the second target coordinates.

5. The method of claim 1, wherein in the step of providing a processor, the processor is a single processor.

6. The method of claim 1, wherein in the step of providing a processor, the processor is a plurality of processors.
